(19) United States
(12) Patent Application Publication
(10) Pub. No.: US 2026/0074254 A1
(43) Pub. Date: Mar. 12, 2026

(54) FLUOROCARBON MOLECULAR ADDITIVES FOR PERFLUOROSULFONIC ACID BASED MEMBRANES

(71) Applicant: GM Global Technology Operations LLC, Detroit, MI (US)

(72) Inventors: Nagappan Ramaswamy, Rochester Hills, MI (US); Richard Wehbe, Berkley, MI (US); Yunzhu Zhang, Rochester Hills, MI (US)

(21) Appl. No.: 18/883,340

(22) Filed: Sep. 12, 2024

(51) Int. Cl. H01M 8/1051; H01M 8/1004; H01M 8/1039; H01M 8/1053; H01M 8/1067; H01M 8/1081

(52) U.S. Cl. CPC H01M 8/1051; H01M 8/1004; H01M 8/1039; H01M 8/1053; H01M 8/1067; H01M 8/1081; H01M 2250/20

(57) ABSTRACT

A proton exchange membrane for an energy conversion device, a hydrogen fuel cell stack for a vehicle, and a method of forming a proton exchange membrane. The proton exchange membrane includes a first layer of a perfluorosulfonic acid ionomer. In addition, the perfluorosulfonic acid ionomer includes a first methoxy-nonafluorobutane coated additive. The hydrogen fuel cell stack includes one or more membrane electrode assemblies, each including a proton exchange membrane.

### INTRODUCTION

Various electrochemical energy conversion devices, such as hydrogen fuel cells for transportation applications and water electrolyzers for hydrogen production, rely upon the use of proton exchange membranes. In fuel cells, a proton exchange membrane is placed between an anode and cathode and serves several functions such as a proton conducting medium, an electrical insulator and a barrier to gas crossover between the anode and cathode. Fuel, such as hydrogen, is provided at the anode, and an oxidizer, such as oxygen from atmospheric air, is provided at the cathode. A catalyst at the anode oxidizes the fuel, generating protons and electrons. The membrane allows the protons to pass through the membrane but prevents the passage of electrons and reactants (the fuel and oxidizer) through the membrane. The electrons pass from the anode to the cathode through an external circuit producing direct current (DC), which may be used by e.g., an electric motor. Another catalyst at the cathode facilitates recombination of the protons, electrons with the oxygen to form water. Hence, a hydrogen fuel cell generates DC power and water as the by-product.

As noted above, a primary function of the proton exchange membrane in fuel cells is to transport or conduct protons from the anode to the cathode. The conductivity of protons is measured in Siemens per centimeter. Proton exchange membranes are commonly composed of ionomers such as perfluorosulfonic acid. Perfluorosulfonic acid-based proton exchange membrane shows a finite but increasing proton conductivity from near room temperature to approximately 110° C. Although the perfluorosulfonic acid shows a relatively higher proton conductivity compared to other ionomers in this temperature window, any further improvement in its conductivity benefits fuel cell and electrolyzer systems. Increasing the proton conductivity of the perfluorosulfonic acid based proton exchange membrane decreases the resistance and increases the efficiency of the electrochemical energy conversion system.

In addition, additives are included in proton exchange membranes to improve chemical and mechanical durability and improve its proton conductivity performance. One such additive is a recombination catalyst, such as platinum, used to address the issue of hydrogen and oxygen “cross-over,” reducing the amount of reactive hydrogen and oxygen gas from the electrodes. Hydrogen “cross-over” occurs when hydrogen (H₂) permeates the proton exchange membrane and reacts with the oxygen on the cathode side. Some amount of hydrogen “cross-over” is unavoidable. A proton exchange membrane becomes more susceptible to hydrogen “cross-over” as the proton exchange membrane degrades due to chemical and mechanical degradation of the membrane. Hydrogen “cross-over” may reduce the performance of the proton exchange membrane. Silica is another additive that is used to enhance the properties of the proton exchange membrane and is understood to improve the water retention properties, thermal stability, mechanical strength, and water retention properties of the membrane. Cerium, manganese salt based additives are used to improve the chemical durability of the membrane. Other additives include graphene, which improves selectivity and mitigates reactant cross-over, and carbon nanotubes.

Similar to fuel cells, polymer electrolyte membrane water electrolyzers also utilizes proton exchange membranes. Polymer electrolyte membrane water electrolyzers operate on the opposite principle of fuel cells by splitting a molecule, such as water, into hydrogen gas and oxygen gas. Water is fed to the anode of an electrolyzer which is then oxidized to form oxygen gas and protons. The protons pass through the membrane and get reduced at the cathode to form hydrogen gas. The proton exchange membrane acts as an electrical insulator while allowing protons to pass through and minimizing gas crossovers between the anode and the cathode. The hydrogen gas may then be used in fuel cells or welding applications. Additional applications that use proton exchange membranes include direct formic acid fuel cells, direct methanol fuel cells, indirect or reformed methanol fuel cells, and direct-ethanol fuel cells, which may be used for several applications including portable fuel cells, stationary fuel cells, and fuel cells for transportation applications. Further, application of proton exchange membrane includes chlor-alkali electrochemical cells to produce chlorine and caustic soda.

It has been found, however, that challenges remain. Again, increases in proton conductivity, improvements in conductivity would increase fuel cell efficiency. In addition, fillers have been found to introduce voids and change the weight and density of the polymer system. This may lower the fatigue resistance and increase membrane susceptibility to water penetration. This may further negatively impact mechanical stability.

Accordingly, room remains for improvement of proton exchange membranes including improvements in proton conductivity. Thus, while present proton exchange membranes, and particularly perfluorosulfonic acid proton exchange membranes achieves their intended purpose, there is a need for new and improved proton exchange membranes.

### SUMMARY OF THE INVENTION

According to various aspects, the present disclosure relates to a proton exchange membrane for an energy conversion device. The proton exchange membrane includes a first layer of a perfluorosulfonic acid ionomer. In addition, the perfluorosulfonic acid ionomer includes a first methoxy-nonafluorobutane coated additive.

In embodiments of the above, the methoxy-nonafluorobutane coated additive includes a recombination catalyst. In further embodiments, the first methoxy-nonafluorobutane coated additive includes platinum on carbon and a weight ratio of the perfluorosulfonic acid ionomer to the first methoxy-nonafluorobutane coated additive is in the range of 1:10 to 1:2000. Alternatively or additionally, the first methoxy-nonafluorobutane coated additive includes an inert particle. Alternatively or additionally, the first methoxy-nonafluorobutane coated additive includes at least one additive selected from the group consisting of silica, carbon black, graphene, and carbon nanotubes.

In any of the above embodiments, the proton exchange membrane also includes an expanded polytetrafluoroethylene membrane including a first side and a second side. The first layer of the perfluorosulfonic acid ionomer contacts the first side of the expanded polytetrafluoroethylene membrane. In further embodiments, the proton exchange membrane further includes a second layer of the perfluorosulfonic acid ionomer contacting a second side of the expanded polytetrafluoroethylene membrane. The second layer of the perfluorosulfonic acid includes a second methoxy-nonafluorobutane coated additive and contacts a second side of the expanded polytetrafluoroethylene membrane. In yet further embodiments, the first methoxy-nonafluorobutane coated additive and the second methoxy-nonafluorobutane coated additive are the same. In additional embodiments, the first layer of the perfluorosulfonic acid ionomer exhibits a first thickness in the range of 4 micrometers to 28 micrometers and the second layer of perfluorosulfonic acid ionomer exhibits a second thickness in the range of 2 micrometers to 28 micrometers. In further additional embodiments, the expanded polytetrafluoroethylene membrane exhibits a third thickness in the range of 1 micrometers to 10 micrometers.

In embodiments of the above, the proton exchange membrane further includes an expanded polytetrafluoroethylene membrane including a first side and a second side. The expanded polytetrafluoroethylene membrane exhibits a thickness in the range of 1 micrometer to 10 micrometers. The first layer of the perfluorosulfonic acid ionomer exhibits a thickness in the range of 4 micrometers to 15 micrometers and contacts the first side of the expanded polytetrafluoroethylene membrane. In addition, the proton exchange membrane includes a second layer of the perfluorosulfonic acid ionomer including a second methoxy-nonafluorobutane coated additive dispersed through the second layer of the perfluorosulfonic acid ionomer. The second layer of the perfluorosulfonic acid exhibits a thickness in the range of 2 micrometers to 6 micrometers and contacts a second side of the expanded polytetrafluoroethylene membrane. The first methoxy-nonafluorobutane coated additive and the second methoxy-nonafluorobutane coated additive includes platinum on carbon, the weight ratio of the first layer of perfluorosulfonic acid ionomer to the first methoxy-nonafluorobutane coated additive is in the range of 1:10 to 1:2000, and the weight ratio of the second layer of perfluorosulfonic acid ionomer to the second methoxy-nonafluorobutane coated additive is in the range of 1:10 to 1:2000.

According to various aspects, the present disclosure also relates to hydrogen fuel cell stack for a vehicle. The hydrogen fuel cell stack includes one or more membrane electrode assemblies. Each membrane electrode assembly includes a proton exchange membrane, an anode including a first gas diffusion layer and a first catalyst disposed on the first gas diffusion layer that contact a first surface of the proton exchange membrane, and a cathode including a second gas diffusion layer and a second catalyst disposed on the second gas diffusion layer that contacts a second surface of the proton exchange membrane. The proton exchange membrane includes a first layer of a perfluorosulfonic acid ionomer, and the perfluorosulfonic acid ionomer includes a first methoxy-nonafluorobutane coated additive present at a weight ratio of the perfluorosulfonic acid ionomer to the first methoxy-nonafluorobutane coated additive is in the range of 1:10 to 1:2000.

In embodiments of the above, the first methoxy-nonafluorobutane coated additive is platinum on carbon. Additionally or alternatively, the first methoxy-nonafluorobutane coated additive an inert particle. Additionally or alternatively, the first methoxy-nonafluorobutane coated additive includes at least one additive selected from the group consisting of silica, carbon black, graphene, and carbon nanotubes.

In any of the above embodiments, the proton exchange membrane includes an expanded polytetrafluoroethylene membrane, the expanded polytetrafluoroethylene membrane including a first side and a second side. The first layer of the perfluorosulfonic acid ionomer contacts the first side of the expanded polytetrafluoroethylene membrane. In further embodiments, the proton exchange membrane includes a second layer of a perfluorosulfonic acid ionomer contacting the second side of the expanded polytetrafluoroethylene membrane. The perfluorosulfonic acid ionomer includes a second methoxy-nonafluorobutane coated additive. In further embodiments, the first layer of the perfluorosulfonic acid ionomer exhibits a first thickness in the range of 4 micrometers to 15 micrometers, the expanded polytetrafluoroethylene membrane exhibits a second thickness in the range of 2 micrometers to 10 micrometers, and the second layer of perfluorosulfonic acid ionomer exhibits a third thickness in the range of 2 micrometers to 15 micrometers, wherein the first thickness is greater than the third thickness.

In any of the above embodiments, the hydrogen fuel cell stack further includes sealing gaskets positioned on either side of each membrane electrode assembly; a bi-polar plate positioned on either side of the membrane electrode assembly, wherein each sealing gaskets is positioned between the membrane electrode assembly and one of the bi-polar plates; and a current collector plate positioned on adjacent each bi-polar plate externally to the membrane electrode assembly.

According to various aspects, the present disclosure is directed to a method of forming a proton exchange membrane. The method includes dispersing an additive in methoxy-nonafluorobutane and coating the additive with methoxy-nonafluorobutane. The method also includes separating the coated additive from excess methoxy-nonafluorobutane and drying the coated additive. The method further includes combining the coated additive and a perfluorosulfonic acid ionomer solution in a solution of alcohol and water to form an ionomer dispersion, forming the ionomer dispersion into the proton exchange membrane, and drying the proton exchange membrane. In addition, the method includes validating the proton conductivity of the dried coated membrane using four probe electrochemical impedance spectroscopy at one or more relative humidities in the range of 40 percent to 100 percent.

In any of the above embodiments, dispersing the additive includes dispersing a recombination catalyst. In further embodiments, dispersing the inert carrier particle comprises dispersing a platinum on carbon catalyst. Additionally or alternatively, dispersing the additive comprises dispersing an inert particle, wherein the coated additive is added in an amount to provide a weight ratio of the perfluorosulfonic acid ionomer to the first methoxy-nonafluorobutane coated additive is in the range of 1:10 to 1:2000. Additionally or alternatively, dispersing the additive comprises dispersing at least one of silica, carbon black, graphene, and carbon nanotubes.

In any of the above embodiments, dispersing the additive in methoxy-nonafluorobutane includes dispersing with by wet grinding for a time period in the range of 1 hour to 48 hours. In further embodiments, the method includes separating the coated additive with a vacuum filter and drying the coated additive at a temperature of 50° C. to 150° C. for 5 minutes to 60 minutes.

In any of the above embodiments, dispersing the additive in methoxy-nonafluorobutane includes dispersing the additive in a solution of methoxy-nonafluorobutane in alcohol.

In any of the above embodiments, the solution of alcohol and water includes alcohol present in the range of 30 percent by volume to 50 percent by volume and water present in the range of 50 percent by volume to 70 percent by volume.

In embodiments of the above, forming the ionomer dispersion into a proton exchange membrane further includes coating a first side of an expanded polytetrafluoroethylene membrane with the ionomer dispersion. In further embodiments, the method includes coating a second side of the expanded polytetrafluoroethylene membrane and drying the coated expanded polytetrafluoroethylene membrane.

### BRIEF DESCRIPTION OF DRAWINGS

The drawings described herein are for illustration purposes only and are not intended to limit the scope of the present disclosure in any way.

FIG. 1 illustrates an embodiment of a vehicle including a fuel cell, according to embodiments of the present disclosure.

FIG. 2 illustrates a fuel cell stack according to embodiments of the present disclosure.

FIG. 3 illustrates a proton exchange membrane according to embodiments of the present disclosure.

FIG. 4 illustrates a method of forming a proton exchange membrane according to embodiments of the present disclosure.

FIG. 5 illustrates proton conductivity (measured in milli Siemens per centimeter, on the vertical, y-axis) measured over a range of percent relative humidity (illustrated on the horizontal, x-axis).

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to coatings of methoxy-nonafluorobutane on additives for perfluorosulfonic acid proton exchange membranes, and perfluorosulfonic acid proton exchange membranes including additives coated with methoxy-nonafluorobutane. The present disclosure also relates to energy conversion devices, and in particular fuel cells and electrolyzers, including perfluorosulfonic acid proton exchange membranes including additives coated with methoxy-nonafluorobutane. The present disclosure further relates to methods of forming perfluorosulfonic acid proton exchange membranes including methoxy-nonafluorobutane coated additives. The above proton exchange membranes are incorporated into energy conversion devices, such as hydrogen fuel cells used in vehicles.

As used herein, the term “vehicle” is not limited to automobiles. While the present technology is described primarily herein in connection with hydrogen fuel cell vehicles, the technology is not limited to hydrogen fuel cell vehicles. The concepts can be used in fuel cells for a wide variety of applications, such as in connection with components used in motorcycles, mopeds, locomotives, aircraft, marine craft, and other vehicles as well as in generators and other power solutions. Further, the proton exchange membranes described herein can be used in other electrochemical conversion devices including electrolyzers, direct formic acid fuel cells, direct methanol fuel cells, indirect or reformed methanol fuel cells, and direct-ethanol fuel cells, chlor-alkaline cells and other related electrochemical devices requiring a solid proton conducting membrane material.

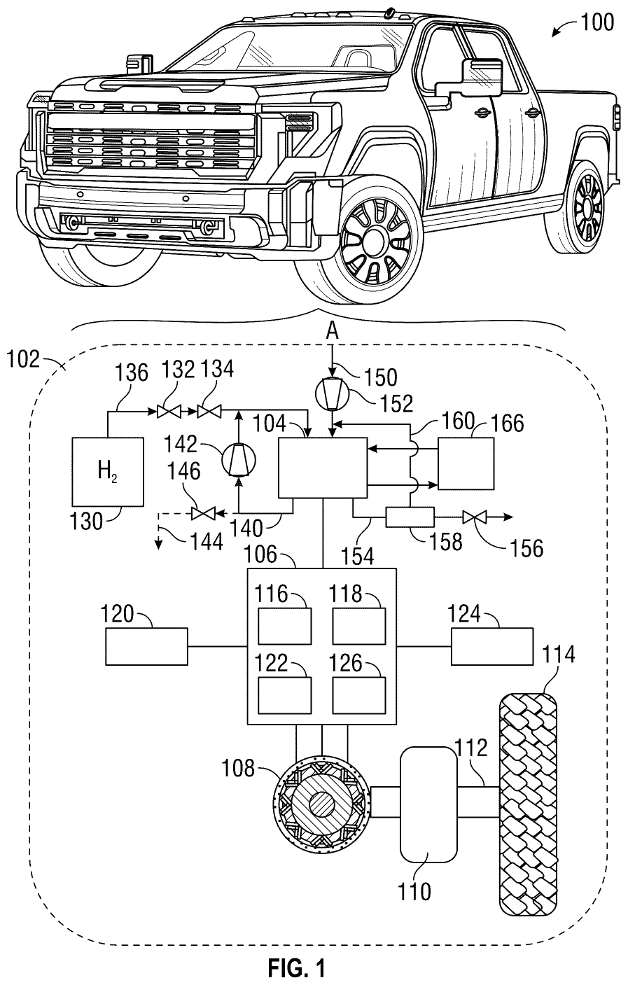

FIG. 1 illustrates a vehicle 100 including a fuel cell powered propulsion system 102. The propulsion system 102 generally includes one or more hydrogen fuel cell stacks 104, which provides power to a power module 106, described further herein. The power module 106 then provides power to an electric motor 108, which in turn is connected to a transmission (drive unit) 110, and drive line 112, which transfers mechanical power and rotation to the wheels 114 of the vehicle. The power module 106 includes a controller 116, which is programmed to control and manage the operations of the electric motor 108 and associated hardware. The controller 116 includes one or more processors and tangible, non-transitory memory 126. The power module 106 also includes a DC/DC converter 118, which regulates the current from the fuel stack 104. In addition, a traction battery 120 is provided to store power generated by the fuel stack 104 and a DC/DC converter 122 is provided in the power module 106 to regulate the charge and discharge of the traction battery 120. Further, a 12V DC/DC converter 124 may be provided to power additional electrical systems associated with the vehicle 100, such as the infotainment system, etc.

Hydrogen H₂ (fuel) is stored under pressure in a tank 130 and is supplied to the fuel cell stack 104 by a supply line 136. A pressure reducer 132 and metering valve 134 are incorporated in the supply line and used to regulate the pressure of the hydrogen and amount of hydrogen provided to the fuel cell stack 104. Excess hydrogen H₂ that is not consumed by the fuel cell stack 104 is reclaimed through reclamation line 140 and carried through the line by a recirculation fan 142. Contaminant gasses and excess water are removed via drain line 144 through a valve 146 that is periodically, or otherwise, actuated.

Oxygen is supplied from ambient air A, which is introduced by an air intake line 150 and compressed by an air compressor 152 in the air intake line 150 before being introduced into the fuel cell stack 104 under pressure. Pressure in the fuel cell stack 104 is adjusted downstream of the fuel cell stack 104 in an exhaust line 154 by a dynamic-pressure control valve 156. A water management system 158 may also be provided to supply moisture, either from the exhaust air passing through the exhaust line 154 or introduced by injecting condensed water into a recirculation line 160. The humid air moistens the proton exchange membrane to maintain a desired relative humidity level. In addition, a coolant system 166 for the fuel cell stack 104 may also be provided. The coolant system may include one or more radiators, one or more fans, and one or more coolant pumps that direct a non-conductive coolant through the fuel cell stack 104.

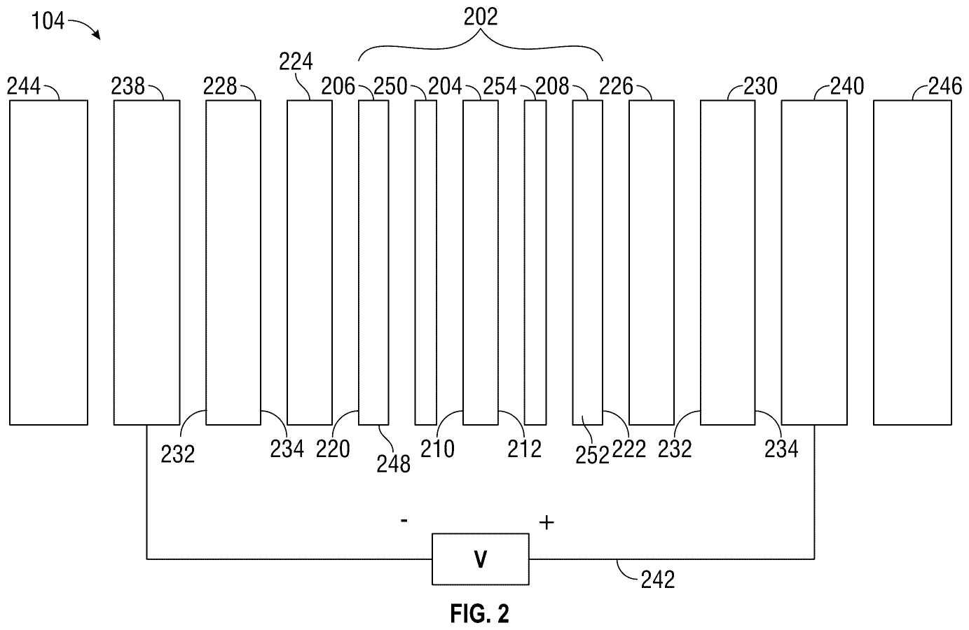

Turning now to FIG. 2, FIG. 2 illustrates a hydrogen fuel cell stack 104 including a membrane electrode assembly 202. The membrane electrode assembly 202 generally includes a proton exchange membrane 204 and two electrodes, an anode 206 and a cathode 208, arranged on either side 210, 212 of the proton exchange membrane 204. It should be appreciated that while only one membrane electrode assembly 202 is illustrated, multiple membrane electrode assemblies 202 may be present in a single fuel cell stack 104. Arranged on either side 220, 222 of the membrane electrode assembly 202 or around the membrane electrode assembly 202 are sealing gaskets 224, 226 that form a seal between the membrane electrode assembly 202 and bi-polar flow field plates 228, 230, which are used to supply fuel such as hydrogen, carbon dioxide, carbon monoxide, and methanol to the anode 206, and an oxidizer such as oxygen to the cathode 208. Current collector plates 238, 240 are provided adjacent to the bi-polar flow field plates 228, 230 exterior to the sealing gaskets 224, 226 and the membrane electrode assembly 202. In addition, end plates 244, 246 are provided exterior to the current collector plates 238, 240 that are used to retain the components of the fuel cell stack 104 together.

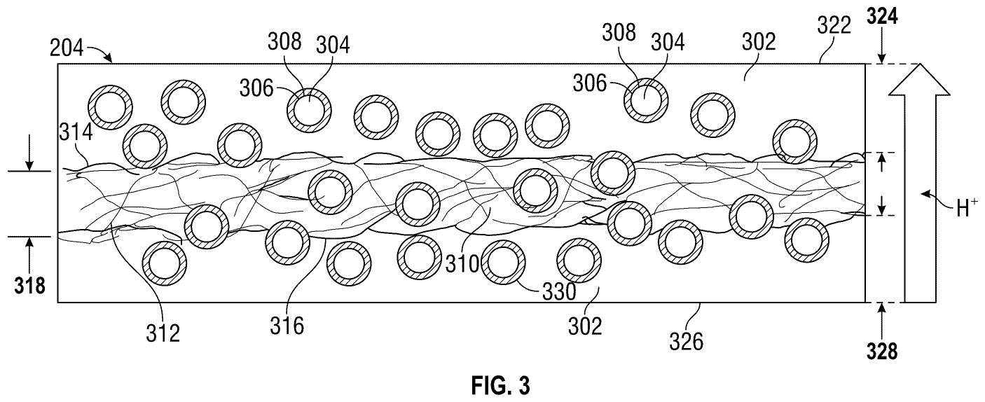

Reference is now made to FIG. 3, which illustrates an embodiment of a proton exchange membrane 204. The proton exchange membrane 204 transports ions, such as hydrogen protons H⁺, through the membrane, from the anode to the cathode, and blocks the passage of electrons or reactant molecules, such as hydrogen H₂ and oxygen O₂, through the membrane. In embodiments, the proton exchange membrane 204 is formed from an ionomer 302 including a methoxy-nonafluorobutane coated additive 330 dispersed throughout the ionomer 302. In further embodiments, an expanded polytetrafluoroethylene membrane 312 is used to support the ionomer 302.

The ionomer 302 is understood as a copolymer that contains both ionic and non-ionic repeat units. In embodiments, the ionomers include a perfluorosulfonic acid ionomer, such as NAFION available from DuPont, or AQUIVION available from Syensqo of Brussels, Belgium. In particular embodiments, the perfluorosulfonic acid ionomer includes sulfonate terminated perfluoro vinyl ether groups pendant from a tetrafluoroethylene backbone. In further embodiments, the ionomer exhibits the chemical formula C₇HF₁₃O₅S·C₂F₄.

Dispersed in the ionomer 302 is the methoxy-nonafluorobutane coated additive 330. In embodiments, the methoxy-nonafluorobutane coated additive 330 is present at a perfluorosulfonic acid ionomer to coated additive weight ratio in the range of 1:10 to 1:2,000 including all values and ranges therein, and preferably in the range of 1:100 to 1:300. Additionally or alternatively, and the methoxy-nonafluorobutane coated additive is present at an areal density in the range of 5 micrograms per centimeter squared to 1000 micrograms per centimeter squared including all values and ranges therein and is preferably from 5 micrograms per centimeter squared to 200 micrograms per centimeters squared, and more preferably from 5 micrograms per centimeter squared to 100 micrograms per centimeter squared.

In embodiments, the additive 304 that is coated includes a recombination catalyst such as platinum on carbon, platinum-transition metal alloys such as platinum-cobalt, platinum, platinum-ruthenium, ruthenium oxide, palladium, and combination thereof. In further embodiments, the recombination catalyst is platinum on carbon. In additional or alternative embodiments, the additive 304 includes at least one of silica, carbon black, graphene, and carbon nanotubes. In further additional or alternative embodiments, the additive 304 includes an inert particle, i.e., a particle that is not chemically reactive with either the components forming the proton exchange membrane 204 or the ions passing through the membrane. However, the inert particles may improve mechanical properties of the proton exchange membrane 204. Inert particles include but are not limited to carbon black, talc, barium sulfate, calcium carbonate, glass fibers, glass beads, alpha-alumina, alumina oxide, silicon dioxide, titanium oxide, and zirconium oxide. In embodiments, the additive 304 exhibits a particle size of 20 nanometer to 1 micron, including all values and increments therein. In further embodiments, the additive 304 exhibits a specific surface area in the range of 10 m²/g to 1000 m²/g, including all values and ranges therein. Particle size may be measured via microscopy and surface area by the Brunauer, Emmett and Teller theory.

Again, the additive 304 is treated with methoxy-nonafluorobutane, creating a coating 306 of methoxy-nonafluorobutane on the additive surface 308. The coating 306 covers at least a portion of the additive surface 308, and in further embodiments, the coating 306 covers the entire additive surface 308. Thus, it should be appreciated that in embodiments, the entire additive surface 308 is not covered by the coating 306. In addition, in embodiments, the methoxy-nonafluorobutane forms a coating 306 having a weight percent of 0.1% to 5% with respect to additive weight loading including all values and ranges therein. In further embodiments, the methoxy-nonafluorobutane coating 306 is present in an amount of 1% to 2% by weight of the total weight of the methoxy-nonafluorobutane and the additive. A non-limiting example of methoxy-nonafluorobutane is NOVEC 7100 Engineering Fluid available from 3M.

In embodiments, the perfluorosulfonic acid ionomer 302, including a methoxy-nonafluorobutane coated additive 330, is formed into a layer having a thickness in the range of 1 micrometer to 20 micrometers, including all values and ranges therein, providing a proton exchange membrane 204.

In further embodiments, the perfluorosulfonic acid ionomer 302 including the methoxy-nonafluorobutane coated additive 330 is reinforced or supported by an expanded polytetrafluoroethylene membrane 312. The expanded polytetrafluoroethylene membrane 312 includes a plurality of micropores 310 dispersed throughout the volume of the expanded polytetrafluorethylene membrane 312, including at the surfaces 314, 316 of the expanded polytetrafluorethylene membrane 312. The perfluorosulfonic acid ionomer 302 penetrates at least a portion of the micropores 310 at the surfaces 314, 316, and in some embodiments the perfluorosulfonic acid ionomer 302 penetrates the entire thickness 318 of the expanded polytetrafluorethylene membrane 312. In embodiments, the expanded polytetrafluoroethylene membrane 312 exhibits a thickness in the range of 1 micrometer to 10 micrometers, including all values and ranges therein. The expanded polytetrafluoroethylene membrane 312 may be either extruded or electro spun.

In embodiments, a first layer 322 of the perfluorosulfonic acid ionomer 302, including a first methoxy-nonafluorobutane coated additive 330, is applied to a first surface 314 of the expanded polytetrafluoroethylene membrane 312. The thickness 324 of the first layer 322 of the perfluorosulfonic acid ionomer 302 is in the range of 4 micrometers to 28 micrometers, including all values and ranges therein. In further embodiments, a second layer 326 of the perfluorosulfonic acid ionomer 302, including a second methoxy-nonafluorobutane coated additive 330, is applied to a second surface 316 of the expanded polytetrafluoroethylene membrane 312. The first and second methoxy-nonafluorobutane coated additive 330 each include an additive 304 individually selected from the additives noted above. In embodiments, the additives 304 of the first and second nonafluorobutane coated additives 330 are the same. The thickness 328 of the second layer 326 of the perfluorosulfonic acid ionomer 302 is in the range of 2 micrometers to 28 micrometers, including all values and ranges therein. In yet further embodiments, the first layer of perfluorosulfonic acid ionomer exhibits a greater thickness than the second layer of the perfluorosulfonic acid ionomer. The total thickness of the proton exchange membrane 204 is in the range of 6 micrometers to 30 micrometers, including all values and ranges therein. Further, the weight ratio of the first layer of perfluorosulfonic acid ionomer to the first methoxy-nonafluorobutane coated additive is in the range of 1:10 to 1:2000, and the weight ratio of the second layer of perfluorosulfonic acid ionomer to the second methoxy-nonafluorobutane coated additive is in the range of 1:10 to 1:2000.

Referring back to FIG. 2, the anode 206 includes a porous gas diffusion layer 248 to enable hydrogen fuel gas to flow through. The gas diffusion layer material includes, but is not limited to, one or more of the following: carbon paper, carbon cloth, woven carbon fabric, non-woven carbon fabric, graphite sheet, titanium meshes, and titanium felts. Further, in embodiments, the gas diffusion layer 248 may be impregnated with polytetrafluoroethylene or other fluoropolymers to alter the hydrophobicity of the gas diffusion layer 248. In embodiments, the thickness of the gas diffusion layer 248 is in the range of 50 micrometers to 300 micrometers, including all values and ranges therein. An anode electrocatalyst 250 is disposed on, and in embodiments, impregnated in, the gas diffusion layer 248. Anode electrocatalysts 250 include one or more catalysts selected from platinum, platinum-transition metal alloys such as platinum-ruthenium and platinum-cobalt, platinum supported on carbon black (Pt/C), iridium black, and iridium oxide. The anode electrocatalyst 250 exhibits a particle size (largest cross-sectional length) in the range of 5 nanometers to 50 nanometers, including all values and ranges therein. In embodiments, the anode electrocatalyst 250 is present at an areal density in the range of 0.05 to 0.5 milligrams of platinum per centimeter squared, including all values and ranges therein. The anode electrocatalyst 250 contacts a first side 210 of the proton exchange membrane 204.

The cathode 208 also includes porous, gas diffusion layer 252 to enable oxygen gas to flow through the cathode. The gas diffusion layer 252 includes, but is not limited to, one or more of the following: carbon paper, carbon cloth, woven carbon fabric, non-woven carbon fabric, graphite sheet, titanium meshes, and titanium felts. Further, in embodiments, the gas diffusion layer 252 may be impregnated with polytetrafluoroethylene or other fluoropolymers to alter the hydrophobicity of the support material 348. The thickness of the gas diffusion layer 252 is in the range of 50 micrometers to 300 micrometers, including all values and ranges therein. A cathode electrocatalyst 254 is disposed on, and in embodiments impregnated in, the gas diffusion layer 252. Cathode electrocatalysts 254 include one or more catalysts selected from platinum, platinum-transition metal alloys such as platinum-ruthenium and platinum-cobalt, platinum supported on carbon black (Pt/C), iridium black, and iridium oxide. The cathode electrocatalyst 254 exhibits a particle size (largest cross-sectional length) in the range of 2 nanometers to 50 nanometers, including all values and ranges therein. In embodiments, the cathode electrocatalyst 254 is present at an areal density in the range of 0.05 to 0.5 milligrams of platinum per centimeter squared, including all values and ranges therein. The cathode electrocatalyst 254 contacts a second side 212 of the proton exchange membrane 204, which opposes the first side 210 of the proton exchange membrane 204.

The sealing gaskets 224, 226 are formed from an elastomeric material and, in embodiments, include one or more of the following materials: natural rubber, styrene-butadiene rubber, butadiene rubber, polyurethane, and thermoplastic elastomers. As noted above, the sealing gaskets 224, 226 are arranged around each membrane electrode assembly 202 or between either side of the membrane electrode assembly 202 and the bi-polar plates 228, 230, with one bi-polar plate 228, 230 positioned on either side of the membrane electrode assembly 202. The bi-polar plates 228, 230 each include a plurality of channels or grooves defined therein that form a flow field to supply the fuel or oxidizer in a relatively uniform manner across the surface of an adjacent electrode (the anode 206 or cathode 208). In embodiments, the bi-polar plates 228, 230 are conductive. For each additional membrane electrode assembly provided, an additional bi-polar plate (and sealing gasket) is provided. In such embodiments, the bi-polar plates 228, 230 are arranged alternatingly with the membrane electrode assemblies 202. Thus, it should be appreciated that in embodiments a single bi-polar plate 228, 230 may provide a flow field on each side 232, 234 of the bi-polar plate 228, 230 for individual membrane electrode assemblies 202.

In embodiments, current collector plates 238, 240, are provided on either side of the bi-polar plates 228, 230, sandwiching the bi-polar flow field plates 228, 230 and the membrane electrode assembly 202. The current collector plates 238, 240 are connected to the circuitry 242 that connects the fuel cell stack 104 to a load, such as the power module 106, or traction battery 120. The current collector plates 238, 240 may be formed at least one of gold, nickel, aluminum, graphite or other conductive materials. In embodiments, the bi-polar flow field plates 228, 230 also provide current collector plates 238, 240 and separate current collector plates 238, 240 are not needed. The membrane electrode assembly 202, sealing gaskets 224, 226, bi-polar flow field plates 228, 230, and current collector plates 238, 240 are sandwiched by end plates 244, 246, which are placed adjacent and externally to the current collector plates 238, 240.

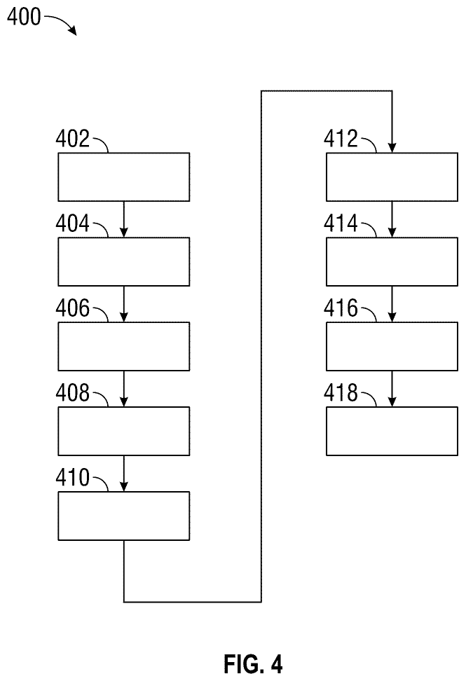

FIG. 4 illustrates embodiments of a method 400 of forming the proton exchange membranes 204 described herein. At block 402 an additive 304 for the proton exchange membrane 204 is dispersed in methoxy-nonafluorobutane. The additive 304 is added to the methoxy-nonafluorobutane at a concentration in the range of 1 gram to 20 grams per 100 milliliters of methoxy-nonafluorobutane. In further embodiments, the methoxy-nonafluorobutane is combined with alcohol having a molar mass in the range of 32 grams per mol to 75 grams per mol, such as isopropyl alcohol, n-butanol, n-propanol, ethanol, and methanol. When a solution of methoxy-nonafluorobutane in alcohol is provided, the methoxy-nonafluorobutane is present in the alcohol at a concentration in the range of 1% to 60%, including all values and increments therein. The alcohol makes up the remainder of the solution. The additive 304 is provided in the solution of methoxy-nonafluorobutane in an alcohol at a concentration in the range of 1 gram to 20 grams per 100 milliliters of methoxy-nonafluorobutane and alcohol. In embodiments, wet grinding is used to disperse the additive 304. Wet grinding includes at least one of the following process: ball milling, roll milling, bead milling, and high shear mixing. In one embodiment, wet grinding is completed by ball milling using for example, 5 millimeter zirconium beads or other milling media. In alternative or additional embodiments, a mixer is used to disperse the additive 304 with the methoxy-nonafluorobutane with or without alcohol. The additive is dispersed in the methoxy-nonafluorobutane, without alcohol, for a time period in the range of 1 hour to 72 hours, including all values and ranges therein, such as 24 hours. During the dispersion process the additive 304 is coated with the methoxy-nonafluorobutane. In embodiments, dispersion assists in deagglomerating the individual particles of the additive increasing the availability of the additive surfaces to receive the methoxy-nonafluorobutane.

At block 404, excess methoxy-nonafluorobutane and alcohol, when present, is separated from the methoxy-nonafluorobutane coated additive. In embodiments, a filter is used to separate the coated additive 330, and in particular embodiments a vacuum filter is used. In alternative embodiments, the coated additives 330 are separated by centrifuge or by a line filter. At block 406, the coated additive 330 is dried at a temperature in the range of 50° C. to 100° C. for a time period in the range of 5 minutes to 30 minutes. In embodiments, the coated additive 330 is dried in an oven, or alternatively in a vacuum drier or drum drier.

At block 408 an ionomer dispersion is formed by combining the methoxy-nonafluorobutane coated additive 330 and a perfluorosulfonic acid ionomer solution in a solution of alcohol and water. The perfluorosulfonic acid ionomer solution includes the perfluorosulfonic acid ionomer dispersed in a solvent. The perfluorosulfonic acid ionomer is present in the range of 1 percent by weight to 25 percent by weight of the total weight of the perfluorosulfonic acid ionomer solution, including all values and ranges therein, and the solvent is present in the range of 75 percent by weight to 99 percent by weight of the total weight of the perfluorosulfonic acid ionomer solution, including all values and ranges therein, wherein the weight percentage totals 100 percent by weight. The solvent includes alcohol, and in preferred embodiments, the solvent includes alcohol and water. The water is present in the range of 35 to 65 percent by weight of the total weight of the solvent and the alcohol is present in the range of 35 to 65 percent by weight of the total weight of the solvent, wherein the total weight of the solvent is 100 percent by weight. Further, the alcohol includes alcohol having a molar mass in the range of 32 grams per mol to 75 grams per mol, such as isopropyl alcohol, n-butanol, n-propanol, ethanol, and methanol.

In embodiments, in the solution of alcohol and water, alcohol is present in the range of 35 to 50 percent by weight of the total weight of the solution and the water is present in the range of 50 to 65 percent by weight of the total weight of the solution and the weight percentage of the solution totals 100 percent. The alcohol could be isopropyl alcohol, n-butanol, n-propanol, ethanol, and methanol.

The perfluorosulfonic acid ionomer solution is added to the ionomer dispersion in the range of 5 percent by weight to 20 percent by weight of the total weight of the ionomer dispersion, including all values and ranges therein, and the coated additive is added to the ionomer dispersion in the range of 0.1 percent by weight to 10 percent by weight of the total weight of the ionomer dispersion, including all values and ranges therein, and the dispersion medium is added to the ionomer dispersion in the mass ratio of 1 to 16 by weight of the total weight of the ionomer dispersion, including all values and ranges therein, wherein the weight percentage totals 100 percent by weight. In embodiments, the ionomer dispersion is mixed by wet grinding. In embodiments, wet grinding is used to disperse the additive 304. Wet grinding includes at least one of the following process: ball milling, roll milling, medial milling, bead milling, and high shear mixing. In one embodiment, wet grinding is completed by ball milling using for example, 5 millimeter zirconium beads or other milling media. In alternative embodiments, the ionomer dispersion is mixed in a mixer. In addition, the ionomer dispersion is mixed for a time period in the range of 1 hour to 72 hours, including all values and ranges therein.

In embodiments, the ionomer dispersion is formed into a proton exchange membrane by casting or extruding the membrane into a desired shape and then the ionomer dispersion is dried to provide the proton exchange membrane.

In further embodiments, the proton exchange membrane is formed by coating the ionomer dispersion onto a carrier, such as the expanded polytetrafluoroethylene membrane. At block 410 a first side of an expanded polytetrafluoroethylene membrane is coated with the ionomer dispersion to form a first layer 322 of perfluorosulfonic acid ionomer including the coated additive 330 dispersed therein. The ionomer dispersion is coated on the expanded polytetrafluoroethylene membrane using one or more coating techniques including, but not limited to, roll casting, spin coating, dip coating, slot die coating, and spray coating. As alluded to above, a sufficient amount of ionomer dispersion is deposited on the expanded polytetrafluoroethylene membrane to form a layer exhibiting a thickness in the range of 4 micrometers to 15 micrometers, including all values and ranges therein, after the coating dispersion is dried. Further, in embodiments, the coated additive is present at an areal density in the range of 5 micrograms per centimeter squared to 1000 micrograms per centimeter squared including all values and ranges therein and is preferably from 5 micrograms per centimeter squared to 200 micrograms per centimeters squared, and more preferably from 5 micrograms per centimeter squared to 100 micrograms per centimeter squared. At block 412 drying the coated membrane is dried at a temperature in the range of 60 to 180° C., including all values and ranges therein, for a time period of 10 minutes to 60 minutes, including all values and ranges therein. In embodiments, the ionomer coated membrane is dried in an oven.

Optionally, at block 414 a second side of an expanded polytetrafluoroethylene membrane is coated with the ionomer dispersion to form a second layer 326 of perfluorosulfonic acid ionomer including the coated additive 330 dispersed therein. The ionomer dispersion is coated on the expanded polytetrafluoroethylene membrane using one or more coating techniques including, but not limited to, roll casting, spin coating, dip coating, slot die coating, and spray coating. As alluded to above, a sufficient amount of ionomer dispersion is deposited on the expanded polytetrafluoroethylene membrane to form a layer exhibiting a thickness in the range of 2 micrometers to 14 micrometers, including all values and ranges therein. Further, in embodiments, the coated additive is present at an areal density in the range of 5 micrograms per centimeter squared to 1000 micrograms per centimeter squared including all values and ranges therein and is preferably from 5 micrograms per centimeter squared to 200 micrograms per centimeters squared, and more preferably from 5 micrograms per centimeter squared to 100 micrograms per centimeter squared. At block 416 the second layer of coated membrane is dried at a temperature in the range of 60degrees C to 180 degrees C., including all values and ranges therein, for a time period of 10 minutes to 60 minutes, including all values and ranges therein. In embodiments, the ionomer coated membrane is dried in an oven.

Also, optionally, at block 418 the proton conductivity of the proton exchange membrane is validated. Proton conductivity may be measured at a variety of relative humidities, such as in the range of 30 percent relative humidity to 100 percent relative humidity including all values and ranges therein. Further, proton conductivity may be measured at a variety of temperatures, such as in the range of 10 degrees Celsius to 150 degrees. Methods of testing in-plane and through-plane proton conductivity are through electrochemical impedance spectroscopy (EIS) with a four-probe or two-probe setup.

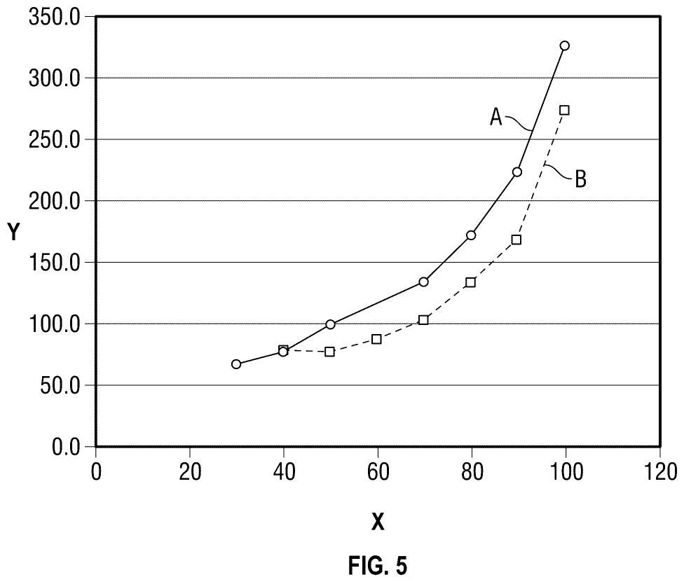

FIG. 5 illustrates a comparative measurement of in-plane proton conductivity with a four-probe EIS setup from BekkTech Conductivity Cell (milli-sieverts per centimeter), illustrated on the vertical, y-axis, as a function of relative humidity (percentage), illustrated on the horizontal, x-axis, for a perfluorosulfonic acid ionomer proton exchange membrane including methoxy-nonafluorobutane modified additive, in this case a platinum catalyst (line A) and a perfluorosulfonic acid ionomer proton exchange membrane with an unmodified platinum catalyst (line B). The membranes were measured at relative humidities in the range of 40 percent and 100 percent. As illustrated, the proton conductivity was generally higher for the proton exchange membrane including the methoxy-nonafluorobutane modified additive at relative humidities of 50 percent and greater.

The proton exchange membrane, hydrogen fuel cells, and methods herein offer a number of advantages. These advantages include, for example, improvement in proton conductivity. These advantages also include, for example, the improvement of the coating of the methoxy-nonafluorobutane modified additive with the ionomer and dispersion of the methoxy-nonafluorobutane modified additive in the ionomer, which is believed to improve proton conductivity. Without being bound to any particular theory, it is also believed that the perfluorosulfonic acid ionomer has enhanced affinity towards the fluorocarbon molecules in the methoxy-nonafluorobutane treated catalyst surface, orienting the sulfonate ion cluster to enable improved conductivity.

As used herein, the term “power module” refers to an assembly containing several interconnected components used to perform power conversion and regulation functions. These components include, but are not limited to controllers, transformers, rectifiers, inverters, converters and other devices used in regulating and distributing power.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 116 may also consist of multiple controllers which are in electrical communication with each other. The controller 116 may be inter-connected with additional systems and/or controllers of the vehicle 100, allowing the controller 116 to access data such as, for example, speed, acceleration, braking, and steering angle of the vehicle 100.

A processor may be a custom made or commercially available processor, a central processing unit (CPU), a graphics processing unit (GPU), an auxiliary processor among several processors associated with the controller 116, a semi composite conductor-based microprocessor (in the form of a microchip or chip set), a macroprocessor, a combination thereof, or generally a device for executing instructions.

The tangible, non-transitory memory 126 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 126 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 116 to control various systems of the vehicle 100.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A proton exchange membrane for an energy conversion device, comprising:
a first layer of a perfluorosulfonic acid ionomer,
wherein the perfluorosulfonic acid ionomer includes a first methoxy-nonafluorobutane coated additive.

2. The proton exchange membrane of claim 1, wherein the methoxy-nonafluorobutane coated additive includes a recombination catalyst.

3. The proton exchange membrane of claim 2, wherein the first methoxy-nonafluorobutane coated additive includes platinum on carbon and a weight ratio of the perfluorosulfonic acid ionomer to the first methoxy-nonafluorobutane coated additive is in the range of 1:10 to 1:2000.

4. The proton exchange membrane of claim 1, wherein the first methoxy-nonafluorobutane coated additive includes an inert particle.

5. The proton exchange membrane of claim 1, wherein the first methoxy-nonafluorobutane coated additive includes at least one additive selected from the group consisting of silica, carbon black, graphene, and carbon nanotubes.

6. The proton exchange membrane of claim 1, further comprising an expanded polytetrafluoroethylene membrane including a first side and a second side, wherein the first layer of the perfluorosulfonic acid ionomer contacts the first side of the expanded polytetrafluoroethylene membrane.

7. The proton exchange membrane of claim 6, further comprising a second layer of the perfluorosulfonic acid ionomer contacting a second side of the expanded polytetrafluoroethylene membrane, wherein the second layer of the perfluorosulfonic acid includes a second methoxy-nonafluorobutane coated additive and contacts a second side of the expanded polytetrafluoroethylene membrane.

8. The proton exchange membrane of claim 7, wherein the first methoxy-nonafluorobutane coated additive and the second methoxy-nonafluorobutane coated additive are the same.

9. The proton exchange membrane of claim 7, wherein the first layer of the perfluorosulfonic acid ionomer exhibits a first thickness in the range of 4 micrometers to 28 micrometers and the second layer of perfluorosulfonic acid ionomer exhibits a second thickness in the range of 2 micrometers to 28 micrometers.

10. The proton exchange membrane of claim 9, wherein the expanded polytetrafluoroethylene membrane exhibits a third thickness in the range of 1 micrometers to 10 micrometers.

11. The proton exchange membrane of claim 1, further comprising:
an expanded polytetrafluoroethylene membrane including a first side and a second side, wherein the expanded polytetrafluoroethylene membrane exhibits a thickness in the range of 1 micrometer to 10 micrometers, wherein the first layer of the perfluorosulfonic acid ionomer exhibits a thickness in the range of 4 micrometers to 15 micrometers and contacts the first side of the expanded polytetrafluoroethylene membrane; and
a second layer of the perfluorosulfonic acid ionomer including a second methoxy-nonafluorobutane coated additive dispersed through the second layer of the perfluorosulfonic acid ionomer, wherein the second layer of the perfluorosulfonic acid exhibits a thickness in the range of 2 micrometers to 6 micrometers and contacts a second side of the expanded polytetrafluoroethylene membrane,
wherein the first methoxy-nonafluorobutane coated additive and the second methoxy-nonafluorobutane coated additive include platinum on carbon, the weight ratio of the first layer of perfluorosulfonic acid ionomer to the first methoxy-nonafluorobutane coated additive is in the range of 1:10 to 1:2000, and the weight ratio of the second layer of perfluorosulfonic acid ionomer to the second methoxy-nonafluorobutane coated additive is in the range of 1:10 to 1:2000.

12. A hydrogen fuel cell stack for a vehicle, comprising:
one or more membrane electrode assemblies, each membrane electrode assembly including:
a proton exchange membrane including first layer of a perfluorosulfonic acid ionomer, wherein the perfluorosulfonic acid ionomer includes a first methoxy-nonafluorobutane coated additive present at a weight ratio of the perfluorosulfonic acid ionomer to the first methoxy-nonafluorobutane coated additive is in the range of 1:10 to 1:2000;
an anode including a first gas diffusion layer and a first catalyst disposed on the first gas diffusion layer, wherein the first catalyst contacts a first surface of the proton exchange membrane; and
a cathode including a second gas diffusion layer and a second catalyst disposed on the second gas diffusion layer, wherein the second catalyst contacts a second surface of the proton exchange membrane.

13. The hydrogen fuel cell stack of claim 12, wherein the first methoxy-nonafluorobutane coated additive is platinum on carbon.

14. The hydrogen fuel cell stack of claim 12, wherein the first methoxy-nonafluorobutane coated additive an inert particle.

15. The hydrogen fuel cell stack of claim 12, wherein the first methoxy-nonafluorobutane coated additive includes at least one additive selected from the group consisting of silica, carbon black, graphene, and carbon nanotubes.

16. The hydrogen fuel cell stack of claim 12, further comprising an expanded polytetrafluoroethylene membrane, the expanded polytetrafluoroethylene membrane including a first side and a second side, wherein the first layer of the perfluorosulfonic acid ionomer contacts the first side of the expanded polytetrafluoroethylene membrane.

17. The hydrogen fuel cell stack of claim 16, further comprising a second layer of a perfluorosulfonic acid ionomer contacting the second side of the expanded polytetrafluoroethylene membrane, wherein the perfluorosulfonic acid ionomer includes a second methoxy-nonafluorobutane coated additive.

18. The hydrogen fuel cell stack of claim 17, wherein the first layer of the perfluorosulfonic acid ionomer exhibits a first thickness in the range of 4 micrometers to 15 micrometers, the expanded polytetrafluoroethylene membrane exhibits a second thickness in the range of 2 micrometers to 10 micrometers, and the second layer of perfluorosulfonic acid ionomer exhibits a third thickness in the range of 2 micrometers to 15 micrometers, wherein the first thickness is greater than the third thickness.

19. The hydrogen fuel cell stack of claim 12, further comprising sealing gaskets positioned on either side of each membrane electrode assembly; a bi-polar plate positioned on either side of the membrane electrode assembly, wherein each sealing gaskets is positioned between the membrane electrode assembly and one of the bi-polar plates; and a current collector plate positioned on adjacent each bi-polar plate externally to the membrane electrode assembly.

20. A method of forming a proton exchange membrane, comprising:
dispersing an additive in methoxy-nonafluorobutane;
coating the additive with methoxy-nonafluorobutane while dispersing;
separating the coated additive from excess methoxy-nonafluorobutane;
drying the coated additive;
combining the coated additive and a perfluorosulfonic acid ionomer solution in a solution of alcohol and water to form an ionomer dispersion;
forming the ionomer dispersion into the proton exchange membrane;
drying the proton exchange membrane; and
validating the proton conductivity of the proton exchange membrane using four probe electrochemical impedance spectroscopy at one or more relative humidities in the range of 40 percent to 100 percent.
